(19) United States
(12) Patent Application Publication
(10) Pub. No.: US 2014/0032380 A1
(43) Pub. Date: Jan. 30, 2014

(54) COMPUTERIZED CARBON FOOTPRINT INVENTORY OF PRODUCTS AND COMPUTNG DEVICE FOR INVENTORYING CARBON FOOTPRINT OF THE PRODUCTS

(71) Applicant: HON HAI PRECISION INDUSTRY CO., LTD., New Taipei (TW)

(72) Inventors: SZU-CHEN LIU, New Taipei (TW); BAO-QUAN CHEN, New Taipei (TW); CHEN-WEI HSU, New Taipei (TW); CHING-WEN LAI, New Taipei (TW)

(73) Assignee: HON HAI PRECISION INDUSTRY CO., LTD., New Taipei (TW)

(21) Appl. No.: 13/854,992

(22) Filed: Apr. 2, 2013

(30) Foreign Application Priority Data
Jul. 25, 2012 (TW) 101126764

(51) Int. Cl. G06Q 10/08

(52) U.S. Cl. CPC G06Q 10/087
USPC 705/28

(57) ABSTRACT

A computerized carbon footprint inventory method of carrying out a carbon footprint inventory of a product is implemented in a computing device. The computing device receives an inventory procedure selected by a user, sets products as inventory targets, loads data as to materials in the product, and determines which materials are to be inventoried according to a weight analysis and according to a carbon dioxide equivalent (CO2e) analysis. The computing device further receives an inventory list uploaded by a vendor, sets a calculation boundary of the carbon footprint inventory and a priority of the material, calculates any uncertainties in relation to the product and the CO2e of the product, generates an inventory report including the uncertainties and the CO2e of the product, and executes an internal verification and an external verification of the inventory report.

### BACKGROUND

1. Technical Field

The present disclosure is related to a method and a computing device for a carbon footprint inventory of a product.

2. Description of Related Art

A plurality of environmental consultant companies may research carbon footprint inventory of a product. In an inventory process of the product, the product is determined at first. If the number of the products is large, final inventory reports are difficult to manage and file because of an excessive number of the inventory reports. Data of materials used by vendors need to be collected. If the number of the vendors is large, the collection of this data is also complicated and difficult. Simultaneously, complicated calculations are applied to the data. If the collection of data is in the form of paper, problems for managing the data are very likely. Otherwise, the results of the carbon footprint inventory, which are inventoried from paper-based data, cannot be analyzed in a diagram for exposing a basic problem, and cannot realistically lead managers towards effective analysis and decisions.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic diagram of one embodiment of a computing device including a carbon footprint inventory system.

FIG. 2 is schematic diagram illustrating operation interfaces within the inventory procedures of a step in inventorying a carbon footprint of a product.

FIG. 3 is schematic diagram illustrating operation interfaces within the inventory procedures of a step in inventorying a carbon footprint of a product.

FIG. 4 is schematic diagram illustrating operation interfaces within the inventory procedures of a step in inventorying a carbon footprint of a product.

FIG. 5 is schematic diagram illustrating operation interfaces within the inventory procedures of a step in inventorying a carbon footprint of a product.

FIG. 6 is schematic diagram illustrating operation interfaces within the inventory procedures of a step in inventorying a carbon footprint of a product.

FIG. 8 is schematic diagram illustrating operation interfaces within the inventory procedures of a step in inventorying a carbon footprint of a product.

FIG. 9 is schematic diagram illustrating operation interfaces within the inventory procedures of a step in inventorying a carbon footprint of a product.

FIG. 10 and FIG. 11 show flowcharts of one embodiment of a method of a carbon footprint inventory of a product using the computing device of FIG. 1.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, flash memory, and hard disk drives.

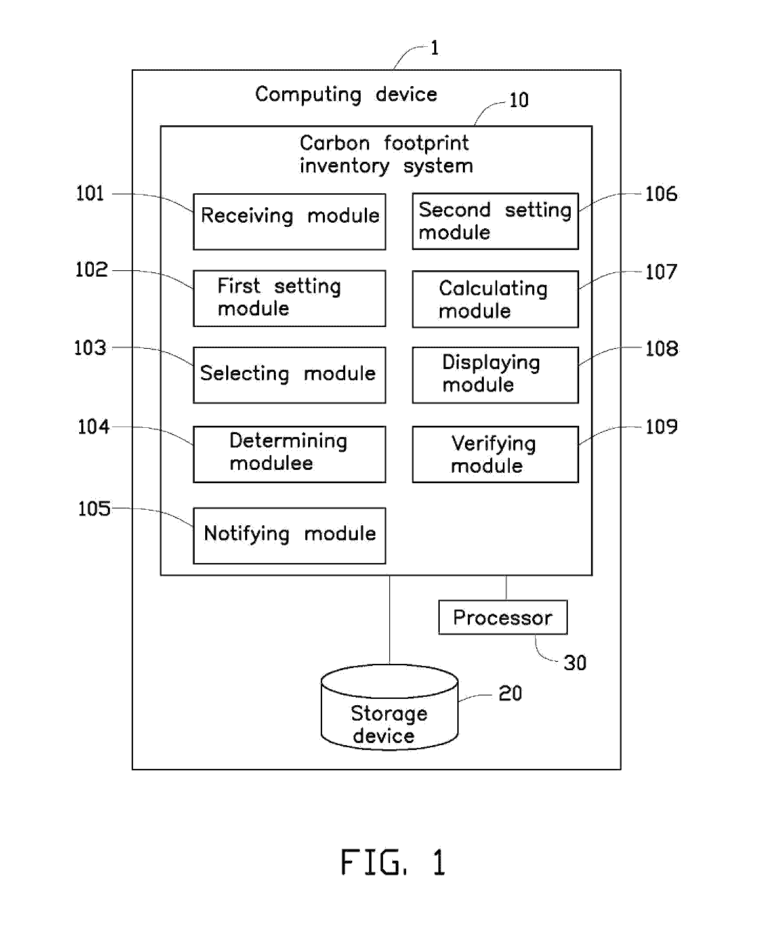

FIG. 1 is a schematic diagram of one embodiment of a computing device 1 including a carbon footprint inventory system 10. In one embodiment, the computing device 1 may be a computer, a server, or a similar electronic device that is capable of processing carbon footprint inventory of a product, such as a motherboard, for example.

In the embodiment, the carbon footprint inventory system 10 is operated by the computing device 1, and inventories how much carbon dioxides equivalent (CO2e) are exhausted at each stage in a life cycle of the product. The CO2e indicates contributions made towards a greenhouse effect of each greenhouse gas. The CO2e of one greenhouse gas can be calculated by multiplying a weight of the greenhouse gas by a parameter of global warming potential (GWP) of the greenhouse gas. In the embodiment, the life cycle of the product includes five stages: a raw material stage, a producing stage, a selling stage, a using stage, and a recycling stage. In another embodiment, the stages of the life cycle of the product may be more or less according to types of different products. The computing device 1 further includes a storage device 20 and at least one processor 30. The storage device 20 saves and manages data, calculations results, and inventory reports which are collected when the carbon footprint inventory system 10 operates.

The carbon footprint inventory system 10 further includes a receiving module 101, a first setting module 102, a selecting module 103, a determining module 104, a notifying module 105, a second setting module 106, a calculating module 107, a displaying module 108, and a verifying module 109. The modules may comprise computerized instructions in the form of one or more programs that are stored in the storage device 20 and executed by the at least one processor 30. In one embodiment, the storage device 20 may be an internal storage system, such as a random access memory (RAM) for temporary storage of information, and/or a read only memory (ROM) for permanent storage of information. In some embodiments, the storage device 20 may also be an external storage system, such as an external hard disk, a storage card, or a data storage medium.

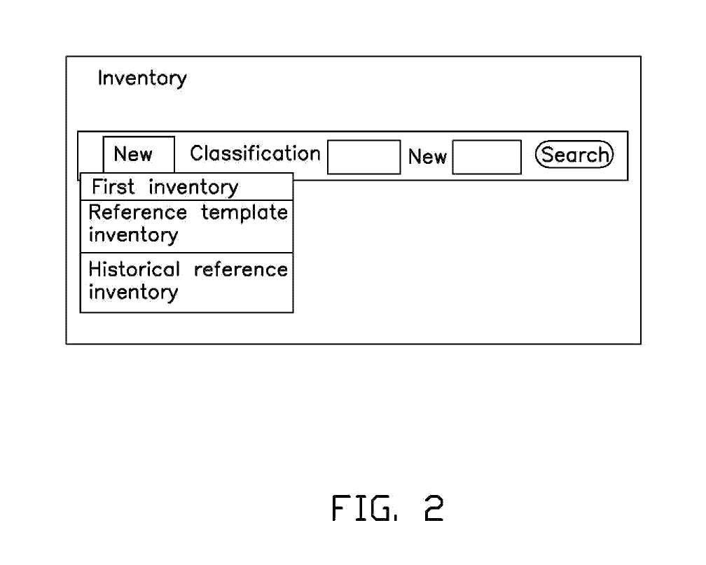

The receiving module 101 receives an inventory procedure of the product selected by a user, and executes an inventory process of the product. The inventory procedure includes a first inventory, a reference template inventory, and a historical reference inventory (shown in FIG. 2) of the product.

When the user selects the first inventory (e.g., by selecting the first inventory displayed on a display screen using a mouse, keyboard, and/or a touchscreen), the first setting module 102 sets standard units and parameters of the inventory processes, and receives the standard units, such as a quality unit and a volume unit, for example, and the parameters, such as life cycle assessment (LCA) parameters and GWP parameters, for example, which are input by the user in the inventory procedures. When the user selects the reference template inventory, the receiving module 101 receives a template selected by the user. Different industries apply different templates. The receiving module 101 loads the standard units and the parameters of the reference template inventory from the storage device 20 to offer the user various reference selections in the inventory processes.

When the user selects the historical reference inventory, the receiving module 101 receives a historical reference report selected by the user. The receiving module 101 copies the standard units and the parameters of the historical reference report to offer the user the same reference selections.

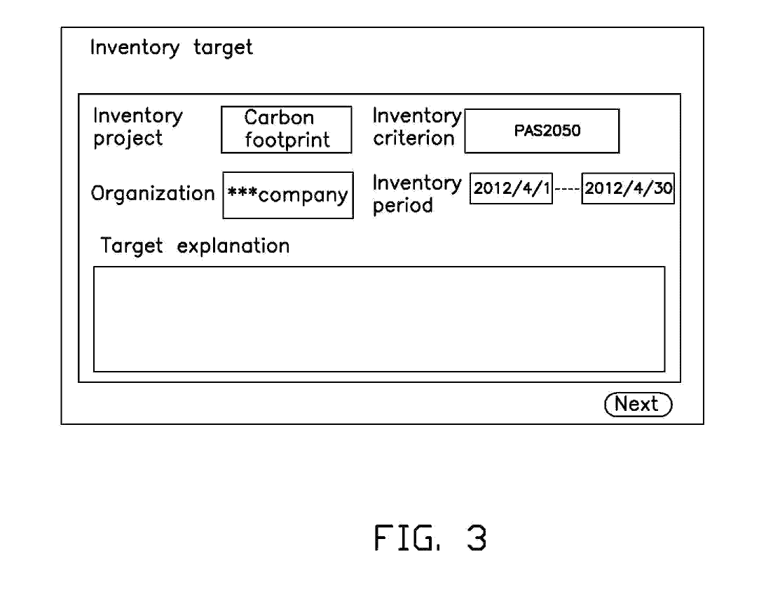

The first setting module 102 sets inventory targets of the carbon footprint inventory of the product, and the inventory targets includes an inventory project, certain inventory criteria, an organization of the product, an inventory period, for example. For example, in FIG. 3, the inventory project is “carbon footprint”, the inventory criterion is “PAS2050”, the organization is a steel company, and the inventory period is from Apr. 1, 2012 to Apr. 30, 2012.

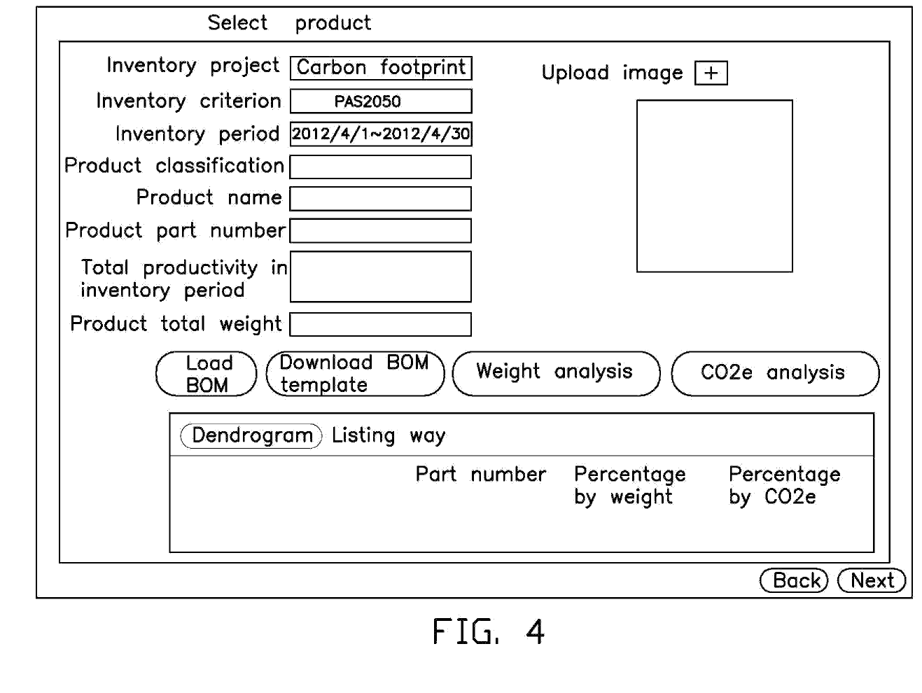

The selecting module 103 selects the product from the organization according to the inventory targets, and loads material data of the product. For example, the organization is a steel company, and the selecting module 103 may select a particular steel plate as the product according to a demand of the user. The selecting module 103 loads the material data of the product according to a bill of materials (BOM). The material data may include a list of materials in the product, and, in relation to each material, a vendor, a part number, weight, for example. The selecting module 103 displays all the materials of the product on a display device of the computing device 1 according to a tree diagram (shown in FIG. 4). The selecting module 103 may further load an image of the product for a reference.

The determining module 104 determines materials of the product (shown in FIG. 4) according to a weight analysis of each material and a CO2e analysis of each material. The product includes a plurality of materials, and the weight of each material may be different. The determining module 104 can determine a weight proportion which is a proportion of the weight of each material to the total weight of the product according to the weight analysis of each material. The determining module 104 picks the materials with greater weight proportions to avoid wasting time on materials with less, or insignificant, weight proportions. For example, the materials with greater weight proportions may be the materials in the top five weight proportions of the product. The determining module 104 can determine a CO2e proportion which is a proportion of the CO2e exhausted from each material to the total CO2e exhausted from the product in the life cycle according to the CO2e analysis of each material. The determining module 104 picks the materials with greater CO2e proportions to inventory.

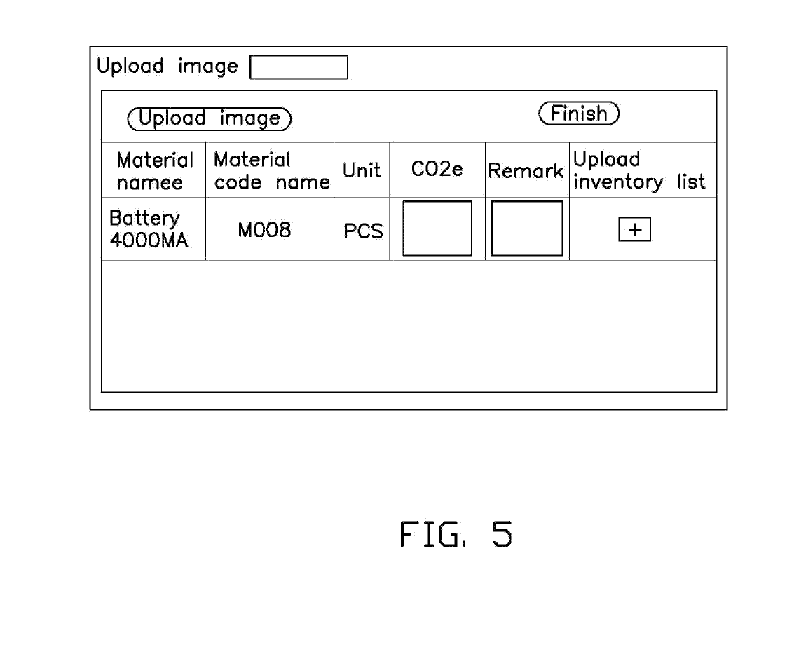

The notifying module 105 gives a notice to the vendor of the material to participate in the carbon footprint inventory, and requests the vendor to inventory the CO2e of the material. The notifying module 105 receives an inventory list uploaded by the vendor. When the vendor receives the notice from the notifying module 105, the vendor can download an inventory reference. The inventory reference includes a plurality of items for consideration in inventorying the material, such as a name of the material, any code name of the material, a unit of measure, for example. The vendor can inventory the CO2e of the material according to the items. The vendor generates the inventory list including the items and a result of the carbon footprint inventory, and uploads the inventory list (shown in FIG. 5).

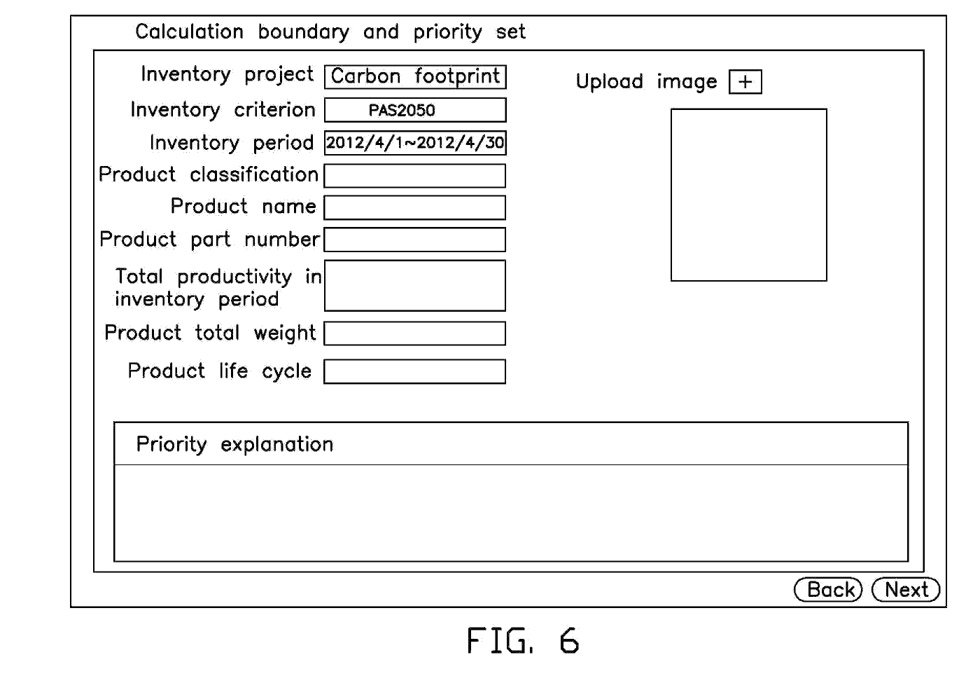

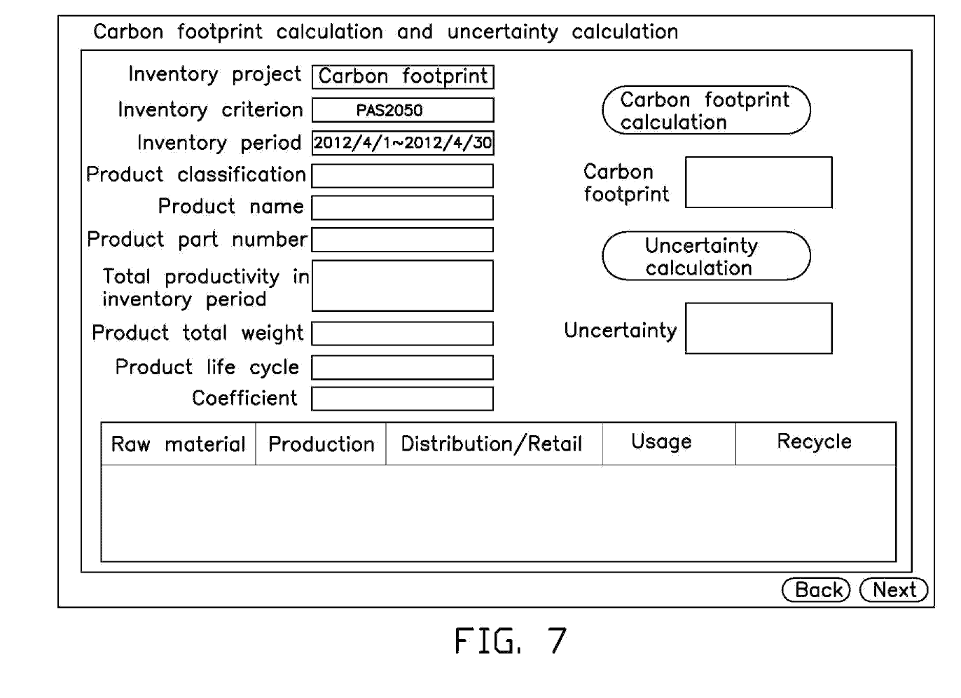

The second setting module 106 sets a calculation boundary of the carbon footprint inventory, and sets priority of the material (shown in FIG. 6). The calculation boundary of the carbon footprint inventory is calculation coverage of the calculating module 107. The calculation coverage includes stages of the life cycle of the product, input content of a carbon footprint calculation, and output content of the carbon footprint calculation. For example, the input content is the total weight of the material in each stage of the life cycle of the product, and the output content is the CO2e of the product in the same stages.

The materials may include a relevant material and a non-relevant material. In the embodiment, the relevant material is a material whose CO2e proportion reaches a preset proportion, one percent, for example. The non-relevant material is a material whose CO2e proportion does not reach the preset proportion. The CO2e proportion is a proportion of the CO2e exhausted from each material in relation to the total CO2e exhausted from the product in the life cycle.

The priority of the relevant materials is higher than the priority of the non-relevant materials. In the relevant material, the priority of a relevant material with greater CO2e proportion is higher than the priority of a relevant material with less CO2e proportion. In the non-relevant material, the priority of a non-relevant material with larger CO2e proportion is higher than the priority of a non-relevant material with less CO2e proportion.

The calculating module 107 calculates the CO2e of the product according to the calculation boundary of the carbon footprint inventory and the priority of the materials. The calculating module 107 calculates any uncertainties or imponderables of the CO2e of the product according to a method for calculating such uncertainties or imponderables (shown in FIG. 7).

A formula for calculating the carbon footprint is multiplying activity level data in the life cycle of the product by an exhausting factor to obtain the CO2e in the life cycle of the product, or multiplying activity level data in some stages of the life cycle of the product by an exhausting factor to obtain the CO2e in some stages of the life cycle of the product. The activity level data includes material activity level data, power activity level data, and waste activity level data. The units of the activity level data may be a kilogram, a cubic meter, a kilowatt, a kilometer, for example. The exhausting factor is the CO2e of the activity level data in each unit. For example, if all of the material activity level data, the power activity level data, and the waste activity level data is fifteen cubic meters and the CO2e in each cubic meter is zero point one kilogram, then the CO2e of the product in life cycle is one point five kilogram, the result of multiplying fifteen by zero point one.

The purpose of calculating any uncertainties in relation to the CO2e of the product is to take account of any uncertainties in a result of a CO2e calculation and minimize the effects of such uncertainties, to raise confidence in the result of the CO2e calculation. The method for calculating such uncertainties may be the Monte Carlo simulation.

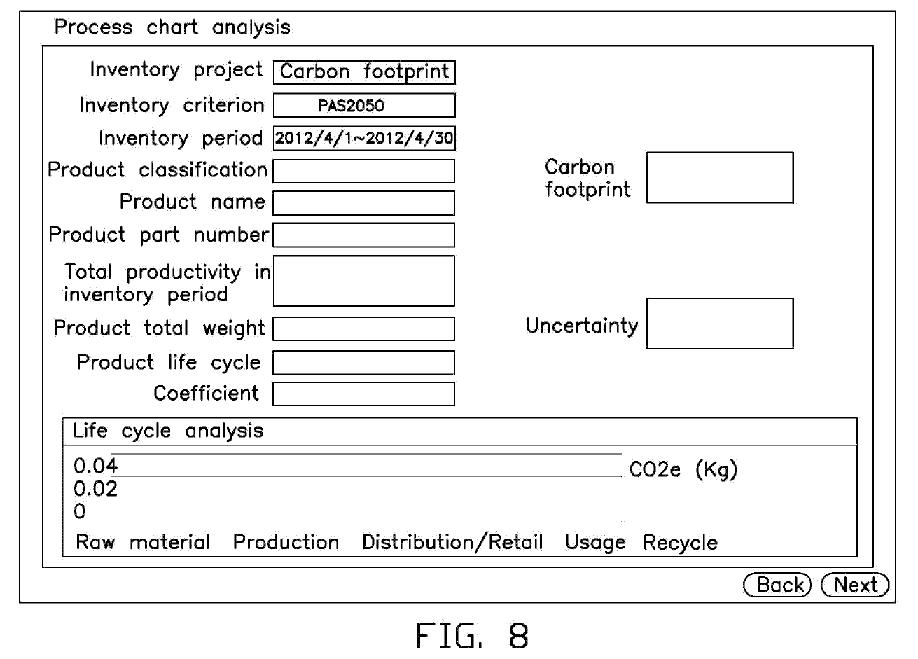

The displaying module 108 generates an inventory report including the CO2e of the product and any uncertainties. The displaying module 108 combines the inventory report with a process chart of each stage in life cycle of the product, and displays the inventory report and the process chart on the display device of the computing device 1. The process chart includes the CO2e and any uncertainties corresponding to each stage in the life cycle of the product. The user can realize CO2e outputs of each stage in the life cycle of the product (shown in FIG. 8).

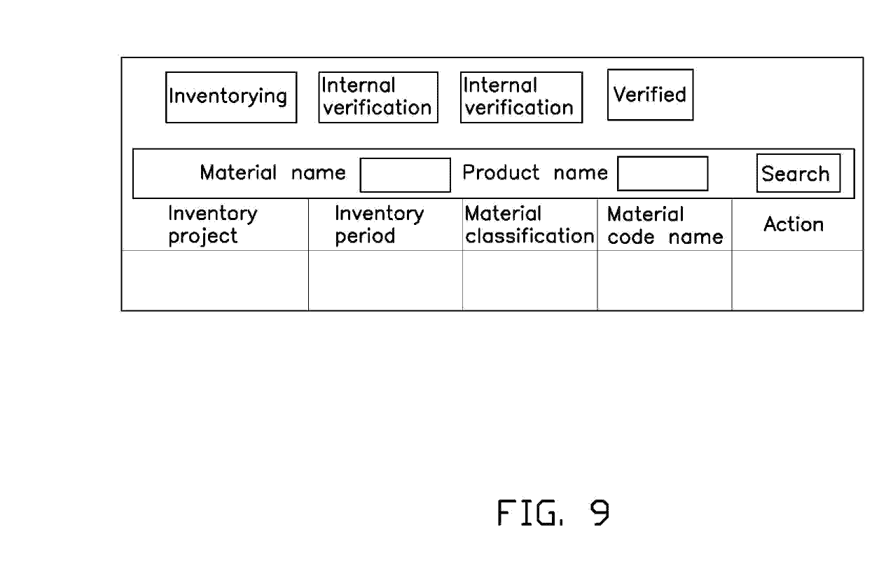

The verifying module 109 executes an internal verification and an external verification according to the inventory report and the process chart (shown in FIG. 9).

In the internal verification, the verifying module 109 gives a notice to an internal verifier of the organization to participate in the internal verification of the product. The verifying module 109 receives a verification record verified by the internal verifier. If some steps of the internal verification have abnormal conditions to be corrected, the internal verification is not passed and the internal verification must be re-verified. If the internal verification is passed, the verifying module 109 gives a notice to an external verifier of the third party to participate in an external verification. The verifying module 109 receives a verification record verified by the external verifier. If some steps of the external verification have abnormal conditions to be corrected, the external verification is not passed and the external verification must be re-verified. When the external verification is passed, the carbon footprint inventory of the product is finished.

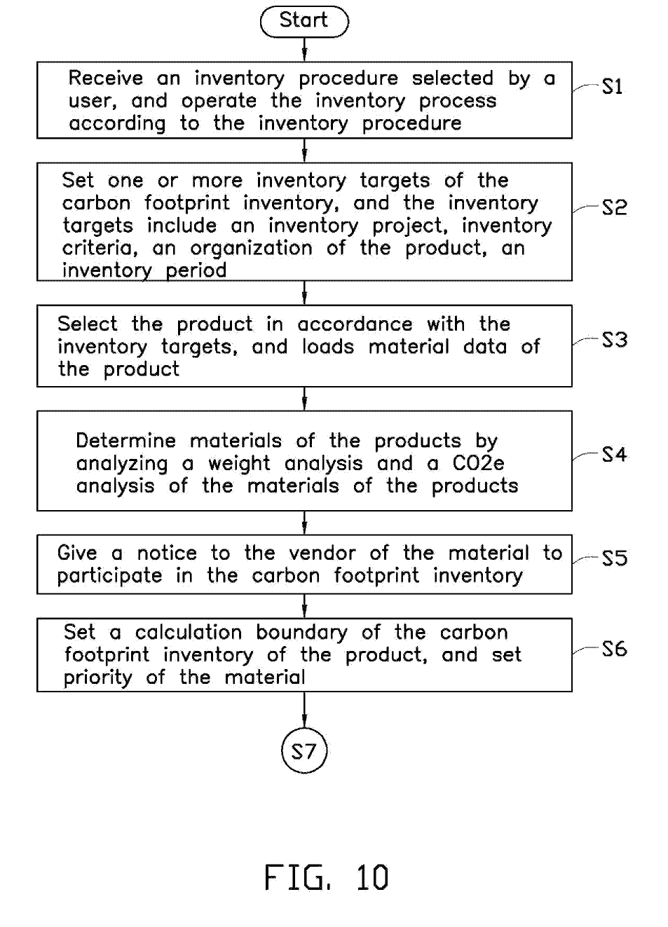

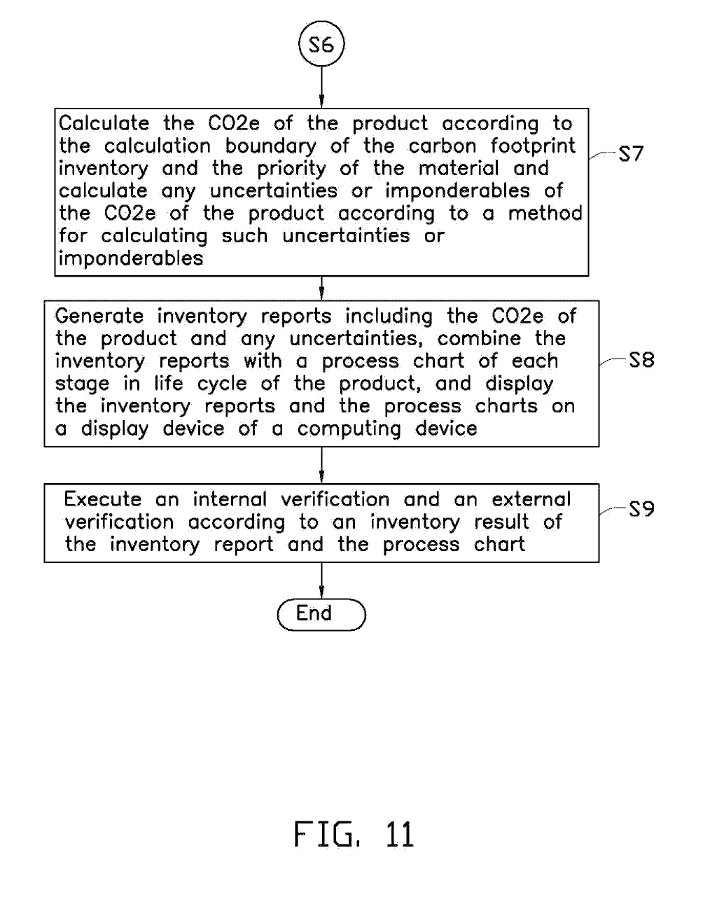

FIG. 10 to FIG. 11 show a flowchart of one embodiment of a method of the carbon footprint inventory of the product using the computing device 1.

In step S1, the receiving module 101 receives an inventory procedure selected by a user, and operates the inventory process according to the inventory procedure selected by the user. The inventory procedure includes a first inventory, a reference template inventory, and a historical reference inventory.

When the user selects the first inventory, step S2 is implemented, and standard units and parameters which are input by the user are received. When the user selects the reference template inventory, the receiving module 101 receives a template selected by the user and loads the standard units and the parameters from the storage device 20 to provide reference selections for the user, and then step S2 is implemented. When the user selects the historical reference inventory, the receiving module 101 receives a history inventory report selected by the user and copies the standard units and the parameters of the history inventory report to provide the reference selections for the user, and then step S2 is implemented.

In step S2, the first setting module 102 sets one or more inventory targets of the carbon footprint inventory. The inventory targets include an inventory project, inventory criteria, an organization of the product, an inventory period, for example, and then step S3 is implemented.

In step S3, the selecting module 103 selects the product from the organization according to the inventory targets, and loads material data of the product. The material data may include a list of materials in the product, and, in relation to each material, a vendor, a part number, weight, for example, and then step S4 is implemented.

In step S4, the determining module 104 determines materials of the products by analyzing a weight analysis of the materials of the products and a CO2e analysis of the materials of the products. A weight proportion which is a proportion of the weight of each material to the total weight of the product can be determined according to the weight analysis. A CO2e proportion which is a proportion of the CO2e exhausted from each material in relation to the total CO2e exhausted from the product in the life cycle can be determined according to the CO2e analysis. The materials with greater weight proportion and the materials with greater CO2e proportion are determined as the materials which are inventoried, and then step S5 is implemented.

In step S5, the notifying module 105 gives a notice to the vendor of the material to participate in the carbon footprint inventory, and requests the vendor to inventory the CO2e of the material. The notifying module 105 receives an inventory list uploaded by the vendor, and then step S6 is implemented.

In step S6, the second setting module 106 sets a calculation boundary of the carbon footprint inventory of the product, and sets priority of the material. The calculation boundary of the carbon footprint inventory is calculation coverage of step S7. The calculation coverage includes stages of the life cycle of the product, input content of a carbon footprint calculation, and output content of the carbon footprint calculation, and then step S7 is implemented.

In one embodiment, the materials include relevant material and non-relevant material. The relevant material is a material whose CO2e proportion reaches a preset proportion. The non-relevant material is a material whose CO2e proportion does not reach the preset proportion. The CO2e proportion is a proportion of the CO2e exhausted from each material in relation to the total CO2e exhausted from the product in the life cycle.

The priority of the relevant material is higher than the priority of the non-relevant material. In the relevant material, the priority of a relevant material with greater CO2e proportion is higher than the priority of a relevant material with less CO2e proportion. In the non-relevant material, the priority of a non-relevant material with greater CO2e proportion is higher than the priority of a non-relevant material with less CO2e proportion.

In step S7, the calculating module 107 calculates the CO2e of the product according to the calculation boundary of the carbon footprint inventory and the priority of the material. The calculating module 107 calculates any uncertainties or imponderables of the CO2e of the product according to a method for calculating such uncertainties or imponderables, and then step S8 is implemented. A formula for calculating the carbon footprint is multiplying activity level data in the life cycle by an exhausting factor to obtain the CO2e in the life cycle of the product, or multiplying activity level data in some stages of the life cycle of the product by the exhausting factor to obtain the CO2e in some stages of the life cycle of the product. The activity level data includes material activity level data, power activity level data, and waste activity level data. The unit of the activity level data may be a kilogram, a cubic meter, a kilowatt, a kilometer, for example. The exhausting factor is the CO2e in each unit of the activity level data. The method for calculating any uncertainties or imponderables may be the Monte Carlo simulation

In step S8, the displaying module 108 generates inventory reports including the CO2e of the product and any uncertainties. The displaying module 108 combines the inventory reports with a process chart of each stage in life cycle of the product, and displays the inventory reports and the process charts on a display device of the computing device 1, and then step S9 is implemented. The process chart includes the CO2e and any uncertainties of each stage in the life cycle of the product. The user can realize CO2e outputs of each stage in the life cycle of the product.

In step S9, the verifying module 109 executes an internal verification and an external verification according to an inventory result of the inventory report and the process chart.

In the internal verification, the verifying module 109 gives a notice to an internal verifier of the organization to participate in the internal verification of the product. The verifying module 109 receives a verification record verified by the internal verifier. If some steps of the internal verification reveal abnormal conditions requiring to be corrected, the internal verification is not passed and the internal verification is re-verified. If the internal verification is passed, the verifying module 109 gives a notice to an external verifier of the third party to participate in the external verification. The verifying module 109 receives a verification record verified by the external verifier of the third party. If some steps of the external verification reveal abnormal conditions requiring to be corrected, the external verification is not passed and the external verification is re-verified. When the external verification is passed, the carbon footprint inventory of the product is finished.

Depending on the embodiment, some of the steps described may be removed, others may be added, and the sequence of the steps may be altered. It is also to be understood that the description and the claims drawn to a method may include some indication in reference to certain steps. However, the indication used is only to be viewed for identification purposes and not necessarily as a suggestion as to an order for the steps.

All of the processes described above may be embodied in, and fully automated via, functional codes executed by one or more general purpose processors of computing devices. The functional codes may be stored in any type of non-transitory computer readable storage medium or other storage device. Some or all of the methods may alternatively be embodied in specialized hardware. Depending on the embodiment, the non-transitory computer readable storage medium may be a hard disk drive, a compact disc, a digital video disc, a tape drive or other suitable storage medium.

The above disclosure is the preferred embodiment. Anyone of ordinary skill in this field can modify and change the embodiment in the spirit of the present disclosure, and all such changes or modifications are to be included in the scope of the following claims.

What is claimed is:

1. A computerized carbon footprint inventory method of a product using a computing device, the method comprising:
receiving an inventory procedure of the product selected by a user and executing an inventory process of the product according to the inventory procedure of the product;
setting inventory targets of the product that comprise an inventory project of the product, inventory criteria of the product, an organization of the product, and an inventory period of the product;
selecting the product from the organization according to the inventory targets and loading material data of the product;
determining a material of the product by analyzing a weight analysis of the material of the product and a carbon dioxide equivalent (CO2e) analysis of the material of the product;
notifying a vendor of the material to participate in a carbon footprint inventory, and receiving an inventory list of the carbon footprint inventory uploaded by the vendor;
setting a calculation boundary of the carbon footprint inventory and priority of the material;
calculating CO2e of the product according to the calculation boundary and the priority of the material of the product;
calculating uncertainties of the CO2e of the product according to an uncertainty calculation of a carbon footprint calculation;
generating an inventory report comprising the CO2e of the product and the uncertainties, and displaying the inventory report on a display device of the computing device; and
executing an internal verification and an external verification according to an inventory result of the inventory report.

2. The computerized carbon footprint inventory method of claim 1, wherein the inventory procedure is selected by performing steps of:
receiving standard units and parameters which are input by the user when the user selects a first inventory of the product;
receiving a template selected by the user, and receiving the standard units and the parameters which are received from a storage device of the computing device to provide reference selections for the user when the user selects a reference template inventory; and
receiving a history inventory report selected by the user, and copying the standard units and the parameters of the history inventory report to provide the reference selections for the user when the user selects a historical reference inventory.

3. The computerized carbon footprint inventory method of claim 1, further comprising:
determining a weight proportion which is a proportion of a weight of each material to a total weight of the product according to the weight analysis;
determining a CO2e proportion which is a proportion of the CO2e exhausted from each material to the total CO2e exhausted from the product in a life cycle according to the CO2e analysis; and
selecting the material of the product according to the weight proportion and the CO2e proportion.

4. The computerized carbon footprint inventory method of claim 1, wherein the calculation boundary of the carbon footprint inventory is calculation coverage, and wherein the calculation coverage comprises stages of the life cycle of the product, input content of the carbon footprint calculation, and output content of the carbon footprint calculation.

5. The computerized carbon footprint inventory method of claim 1,
wherein the priority of a relevant material is higher than the priority of a non-relevant material;
wherein the relevant material indicates that the CO2e proportion of the relevant material reaches a preset proportion; and
wherein the non-relevant material indicates that the CO2e proportion of the non-relevant material does not reach the preset proportion.

6. The computerized carbon footprint inventory method of claim 5,
wherein the priority of a relevant material with greater CO2e proportion is higher than the priority of a relevant material with less CO2e proportion; and
wherein the priority of a non-relevant material with greater CO2e proportion is higher than the priority of a non-relevant material with less CO2e proportion.

7. The computerized carbon footprint inventory method of claim 1, further comprising:
generating a process chart according to the CO2e and the uncertainties which are combined with the life cycle of the product;
displaying the process chart on the display device; and
wherein the process chart comprises each stage of the life cycle of the product corresponding to the CO2e and the uncertainties.

8. A computing device for inventorying carbon footprint of a product, the computing device comprising:
a storage device;
at least one processor; and
one or more modules stored in the storage device and executed by the at least one processor, the one or more modules comprising:
a receiving module configured to receive an inventory procedure of the product selected by a user, and to execute an inventory process of the product according to the inventory procedure of the product;
a first setting module configured to set inventory targets of the product that comprise an inventory project of the product, inventory criteria of the product, an organization of the product, and an inventory period of the product;
a selecting module configured to select the product from the organization according to the inventory targets, and to load material data of the product;
a determining module configured to determine a material of the product by analyzing a weight analysis of the material of the product and a carbon dioxide equivalent (CO2e) analysis of the material of the product;
a notifying module configured to notify a vendor of the material to participate in a carbon footprint inventory, and to receive an inventory list of the carbon footprint inventory uploaded by the vendor;
a second setting module configured to set a calculation boundary of the carbon footprint inventory and priority of the material;
a calculating module configured to calculate CO2e of the product according to the calculation boundary and the priority of the material of the product, and to calculate uncertainties of the CO2e of the product according to an uncertainty calculation of a carbon footprint calculation;
a displaying module configured to generate an inventory report which comprises the CO2e of the product and the uncertainties, and to display the inventory report on a display device of the computing device; and
a verifying module configured to execute an internal verification and an external verification according to an inventory result of the inventory report.

9. The computing device of claim 8, wherein the inventory procedure is selected by performing steps of:
receiving standard units and parameters which are input by the user when the user selects a first inventory of the product;
receiving a template selected by the user, and receiving the standard units and the parameters which are received from a storage device of the computing device to provide reference selections for the user when the user selects a reference template inventory; and
receiving a history inventory report selected by the user, and copying the standard units and the parameters of the history inventory report to provide the reference selections for the user when the user selects a historical reference inventory.

10. The computing device of claim 8, the determining module further configured to:
determine a weight proportion which is a proportion of a weight of each material to a total weight of the product according to the weight analysis;
determine a CO2e proportion which is a proportion of the CO2e exhausted from each material to the total CO2e exhausted from the product in a life cycle according to the CO2e analysis; and
select the material of the product according to the weight proportion and the CO2e proportion.

11. The computing device of claim 8, wherein the calculation boundary of the carbon footprint inventory is calculation coverage, and wherein the calculation coverage comprises stages of the life cycle of the product, input content of the carbon footprint calculation, and output content of the carbon footprint calculation

12. The computing device of claim 8,
wherein the priority of a relevant material is higher than the priority of a non-relevant material;
wherein the relevant material indicates that the CO2e proportion of the relevant material reaches a preset proportion; and
wherein the non-relevant material indicates that the CO2e proportion of the non-relevant material does not reach the preset proportion.

13. The computing device of claim 12,
wherein the priority of a relevant material with greater CO2e proportion is higher than the priority of a relevant material with less CO2e proportion; and
wherein the priority of a non-relevant material with greater CO2e proportion is higher than the priority of a non-relevant material with less CO2e proportion.

14. The computing device of claim 8, the displaying module further configured to:
generate a process chart according to the CO2e and the uncertainties which are combined with the life cycle of the product;
displaying the process chart on the display device; and
wherein the process chart comprises each stage of the life cycle of the product corresponding to the CO2e and the uncertainties.

15. A non-transitory computer-readable storage medium having stored thereon instructions that, when executed by at least one processor of a computing device, cause the computing device to perform a computerized carbon footprint inventory of a product, the computerized carbon footprint inventory comprising:
receiving an inventory procedure of the product selected by a user and executing an inventory process of the product according to the inventory procedure of the product;
setting inventory targets of the product that comprise an inventory project of the product, inventory criteria of the product, an organization of the product, and an inventory period of the product;
selecting the product from the organization according to the inventory targets and loading material data of the product;
determining a material of the product by analyzing a weight analysis of the material of the product and a carbon dioxide equivalent (CO2e) analysis of the material of the product;
notifying a vendor of the material to participate in a carbon footprint inventory, and receiving an inventory list of the carbon footprint inventory uploaded by the vendor;
setting a calculation boundary of the carbon footprint inventory and priority of the material;
calculating CO2e of the product according to the calculation boundary and the priority of the material of the product;
calculating uncertainties of the CO2e of the product according to an uncertainty calculation of a carbon footprint calculation;
generating an inventory report which comprises the CO2e of the product and the uncertainties, and displaying the inventory report on a display device of the computing device; and
executing an internal verification and an external verification according to an inventory result of the inventory report.

16. The storage medium of claim 15, wherein the inventory procedure is selected by performing steps of:
receiving standard units and parameters which are input by the user when the user selects a first inventory of the product;
receiving a template selected by the user, and receiving the standard units and the parameters which are received from a storage device of the computing device to provide reference selections for the user when the user selects a reference template inventory; and
receiving a history inventory report selected by the user, and copying the standard units and the parameters of the history inventory report to provide the reference selections for the user when the user selects a historical reference inventory.

17. The storage medium of claim 15, wherein the computerized carbon footprint inventory further comprises:
determining a weight proportion which is a proportion of a weight of each material to a total weight of the product according to the weight analysis;
determining a CO2e proportion which is a proportion of the CO2e exhausted from each material to the total CO2e exhausted from the product in a life cycle according to the CO2e analysis; and
selecting the material of the product according to the weight proportion and the CO2e proportion.

18. The storage medium of claim 15, wherein the calculation boundary of the carbon footprint inventory is calculation coverage, and wherein the calculation coverage comprises stages of the life cycle of the product, input content of the carbon footprint calculation, and output content of the carbon footprint calculation.

19. The storage medium of claim 15,
wherein the priority of a relevant material is higher than the priority of a non-relevant material;
wherein the relevant material indicates that the CO2e proportion of the relevant material reaches a preset proportion; and
wherein the non-relevant material indicates that the CO2e proportion of the non-relevant material does not reach the preset proportion.

20. The storage medium of claim 19,
wherein the priority of a relevant material with greater CO2e proportion is higher than the priority of a relevant material with less CO2e proportion; and
wherein the priority of a non-relevant material with greater CO2e proportion is higher than the priority of a non-relevant material with less CO2e proportion.

21. The storage medium of claim 15, the computerized carbon footprint inventory further comprises:
generating a process chart according to the CO2e and the uncertainties which are combined with the life cycle of the product;
displaying the process chart on the display device; and
wherein the process chart comprises each stage of the life cycle of the product corresponding to the CO2e and the uncertainties.
